(19) United States
(12) Patent Application Publication
(10) Pub. No.: US 2026/0353282 A1
(43) Pub. Date: Nov. 5, 2026

(54) DYNAMIC POWER SAVING SUPPORT NEGOTIATION FOR A SCHEDULED POWER SAVING SCHEME

(71) Applicant: NEWRACOM, Inc., Irvine, CA (US)

(72) Inventors: Jaehyuk CHOI, Seongnam (KR); Joonsoo LEE, Irvine, CA (US)

(73) Assignee: NEWRACOM, Inc., Irvine, CA (US)

(21) Appl. No.: 19/659,946

(22) Filed: Apr. 27, 2026

Related U.S. Application Data
(60) Provisional application No. 63/797,540, filed on Apr. 30, 2025.

(51) Int. Cl. H04W 52/02

(52) U.S. Cl. CPC H04W 52/0216

(57) ABSTRACT

A method performed by a station (STA) to negotiate dynamic power saving support for a scheduled power saving scheme with an access point (AP). The method includes transmitting a setup request frame to the AP to initiate negotiation of parameters of the scheduled power saving scheme with the AP and receiving a setup response frame from the AP as a response to the setup request frame, wherein the setup response frame includes an indication of whether dynamic power saving is supported during a service period of the scheduled power saving scheme.

### CROSS-REFERENCE TO RELATED APPLICATION

This application claims the benefit of U.S. Provisional Application No. 63/797,540, filed Apr. 30, 2025, titled “Dynamic Power Save (DPS) Capability Negotiation in TWT Setup for r-TWT Operation”, which is hereby incorporated by reference.

### TECHNICAL FIELD

The present disclosure generally relates to wireless communications, and more specifically, relates to negotiating dynamic power saving support for a scheduled power saving scheme.

### BACKGROUND

Institute of Electrical and Electronics Engineers (IEEE) 802.11 is a set of standards for implementing wireless local area network communication in various frequencies, including but not limited to the 2.4 gigahertz (GHz), 5 GHz, 6 GHz, and 60 GHz bands. These standards define the protocols that enable Wi-Fi devices to communicate with each other. The IEEE 802.11 family of standards has evolved over time to accommodate higher data rates, improved security, and better performance in different environments. Some of the most widely used standards include 802.11a, 802.11b, 802.11g, 802.11n, 802.11ac, and 802.11ax (also known as “Wi-Fi 6”). These standards specify the modulation techniques, channel bandwidths, and other technical aspects that facilitate interoperability between devices from various manufacturers. IEEE 802.11 has played an important role in the widespread adoption of wireless networking in homes, offices, and public spaces, enabling users to connect their devices to the internet and each other without the need for wired connections.

In IEEE 802.11 wireless networks, restricted target wake time (r-TWT) service periods (SPs) are designed to provide low-latency transmissions with contention-free channel access, which make them particularly effective for guaranteeing quality of service (QoS) for delay-sensitive applications. r-TWT SPs can be configured to manage the wake and transmission schedules of individual stations (STAs). Furthermore, the r-TWT concept has been extended to support group-based SPs during which multiple selected STAs are provided contention-free access during the same SP window.

Existing r-TWT implementations assume that all member STAs of the SP operate in a fully operational state (e.g., operate in a high capability mode) for the entire duration of the SP, regardless of their actual transmission needs. This static power model fails to accommodate dynamic power save (DPS) mechanisms that allow STAs to dynamically switch between operating in different power consumption modes (e.g., a low capability (LC) mode and a high capability (HC) mode) based on real-time traffic demands. As a result, group-based r-TWT SPs can cause members STAs to unnecessarily consume significant amounts of power by forcing member STAs that do not have immediate transmission needs to operate in a fully operational mode (e.g., the high capability mode) for the entire duration of the SP. This problem may be especially pronounced in group scenarios, where many STAs need to simultaneously stay awake even if only a few of them are actively transmitting at a given moment.

### BRIEF DESCRIPTION OF THE DRAWINGS

The disclosure will be more fully understood from the detailed description provided below and the accompanying drawings that depict various embodiments of the disclosure. However, these drawings should not be interpreted as limiting the disclosure to the specific embodiments shown; they are provided for explanation and understanding only.

FIG. 1 illustrates an example of a wireless local area network (WLAN) with a basic service set (BSS) that includes multiple wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates interframe space (IFS) relationships, in accordance with some embodiments of the present disclosure.

FIG. 5 illustrates a Carrier Sense Multiple Access with Collision Avoidance (CSMA/CA)-based frame transmission procedure, in accordance with some embodiments of the present disclosure.

FIG. 6 illustrates maximum physical layer (PHY) rates for Institute of Electrical and Electronics Engineers (IEEE) 802.11 standards, in accordance with some embodiments of the present disclosure.

FIG. 7 provides a detailed description of fields in Extremely High Throughput (EHT) Physical Protocol Data Unit (PPDU) frames, including their purposes and characteristics, in accordance with some embodiments of the present disclosure.

FIG. 8 illustrates an example of multi-user (MU) transmission in Orthogonal Frequency-Division Multiple Access (OFDMA), in accordance with some embodiments of the present disclosure.

FIG. 9 illustrates an example of an access point sending a trigger frame to multiple associated stations and receiving Uplink Orthogonal Frequency-Division Multiple Access Trigger-Based Physical Protocol Data Units (UL OFDMA TB PPDUs) in response, in accordance with some embodiments of the present disclosure.

FIG. 10 is a diagram showing a wireless network environment that can implement restricted target wake time (r-TWT), according to some embodiments.

FIG. 11 is a diagram showing a frame exchange sequence for implementing a target wake time (TWT) setup procedure and a r-TWT SP, according to some embodiments.

FIG. 12 is a diagram showing a TWT negotiation procedure, according to some embodiments.

FIG. 13 is a table showing a summary of the TWT conditions after certain TWT setup command exchanges, according to some embodiments.

FIG. 14 is a diagram showing TWT element format, according to some embodiments.

FIG. 15 is a diagram showing dynamic power save (DPS) operations, according to some embodiments.

FIG. 16 is a diagram showing a TWT setup procedure that integrates DPS support negotiation, according to some embodiments.

FIG. 17 is a diagram showing a TWT element format that includes a new ultra high reliability (UHR) power save capability field to signal DPS support, according to some embodiments.

FIG. 18 is a diagram showing a broadcast TWT parameter set field format, according to some embodiments.

FIG. 19 is a table showing a summary of DPS support negotiation handling for certain TWT setup command exchanges, according to some embodiments.

FIG. 20 is a flow diagram of a TWT setup procedure that integrates DPS support negotiation, according to some embodiments.

FIG. 21 is a flow diagram of a TWT setup procedure where an AP modifies the DPS support setting, according to some embodiments.

FIG. 22 is a diagram showing a TWT setup procedure where an AP dictates the DPS support setting, according to some embodiments.

FIG. 23 is a flow diagram of a method for negotiating dynamic power saving support for a scheduled power saving scheme (from the perspective of a STA), according to some embodiments.

FIG. 24 is a flow diagram of a method for negotiating dynamic power saving support for a scheduled power saving scheme (from the perspective of an AP or other scheduling entity), according to some embodiments.

### DETAILED DESCRIPTION

The present disclosure generally relates to wireless communications, and more specifically, relates to negotiating dynamic power saving support for a scheduled power saving scheme.

As mentioned above, existing restricted target wake time (r-TWT) implementations assume that all member stations (STAs) of a service period (SP) operate in a fully operational state (e.g., operate in a high capability mode) for the entire duration of the SP, regardless of their actual transmission needs. This static power model fails to accommodate dynamic power save (DPS) mechanisms that allow STAs to dynamically switch between operating in different power consumption modes (e.g., a low capability (LC) mode and a high capability (HC) mode) based on real-time traffic demands. As a result, group-based r-TWT SPs can cause members STAs to unnecessarily consume significant amounts of power by forcing member STAs that do not have immediate transmission needs to operate in a fully operational mode (e.g., the high capability mode) for the entire duration of the SP. This problem may be especially pronounced in group scenarios, where many STAs need to simultaneously stay awake even if only a few of them are actively transmitting at a given moment.

Currently, there is no way to indicate whether DPS is supported during a group-based r-TWT service period, nor is there a way to manage DPS mode transitions without disrupting the contention-free nature and strict timing guarantees of the r-TWT framework.

To address one or more of the limitations of existing r-TWT implementations, the present disclosure describes a DPS support negotiation mechanism for explicitly negotiating support for DPS during the TWT setup phase for r-TWT sessions. With the DPS support negotiation mechanism described herein, the AP and participating STAs may negotiate whether DPS will be supported during the r-TWT SPs during the TWT setup phase (for initial scheduling, group formation, or dynamic updates).

In an embodiment, an AP and a STA use extended TWT setup request frames and TWT setup response frames that include a new DPS support field that allows both parties to specify and agree upon whether DPS operations (e.g., dynamic mode transitions between low capability mode and high capability mode) are supported/permitted during the r-TWT SP.

If DPS support is agreed upon (DPS operations are permitted), STAs may operate in the low capability mode during the SP when they do not have any active transmission needs, and dynamically transition to operating in the high capability mode only when necessary. The DPS mode transition (e.g., LC-to-HC mode transition) may be coordinated via lightweight signaling. For example, the AP may initiate the DPS mode transition by transmitting an initial control frame (ICF) to a STA to cause the STA to transition from operating in the low capability mode to operating in the high capability mode. The STA may respond to the initial control frame by transmitting an initial control response frame (ICR) to confirm successful DPS mode transition. This signaling may ensure deterministic and contention-free DPS mode transitions that are aligned with scheduled transmission events.

The explicit DPS support negotiation during the TWT setup phase and the tight coordination of DPS mode transitions during the r-TWT SP may provide one or more of the technological advantages mentioned below.

Enhanced energy efficiency: Member STAs of a r-TWT SP can remain operating in the low capability mode when they do not have any transmission needs, thereby reducing unnecessary power consumption across the group.

Preservation of contention-free access: The deterministic and lightweight DPS mode transition signaling (e.g., via ICF/ICR exchange) may ensure that the dynamic mode transitions do not disrupt the strict latency guarantees of r-TWT SPs.

Increased scheduling flexibility: Only STAs with pending transmissions transition to operating in the high capability mode, thereby optimizing channel usage and improving overall network efficiency.

The DPS support negotiation mechanism described herein may thus enable energy-efficient and QoS-compliant operations in next-generation wireless networks.

For sake of explanation only, various embodiments are primarily described in the context of a wireless network that implements r-TWT and DPS. However, the techniques and concepts described herein are not limited to being used with these specific technologies. The techniques and concepts described herein may be used with other types of scheduled power saving schemes besides r-TWT and/or other types of dynamic power saving schemes besides DPS.

An embodiment is a method performed by a STA to negotiate dynamic power saving support for a scheduled power saving scheme with an AP. The method includes transmitting a setup request frame to the AP to initiate negotiation of parameters of the scheduled power saving scheme with the AP and receiving a setup response frame from the AP as a response to the setup request frame, wherein the setup response frame includes an indication of whether dynamic power saving is supported during a service period of the scheduled power saving scheme. The method may further include responsive to determining, based on the indication, that dynamic power saving is supported during the service period, operating in a low capability mode of a dynamic power saving scheme when the service period begins and transitioning to operating in a high capability mode of the dynamic power saving scheme during the service period when triggered by the AP.

An embodiment is a method performed by an AP to negotiate dynamic power saving support for a scheduled power saving scheme. The method includes receiving a setup request frame from the STA that initiates negotiation of parameters of the scheduled power saving scheme, responsive to receiving the setup request frame, determining whether to support dynamic power saving during a service period of the scheduled power saving scheme, and transmitting a setup response frame to the STA as a response to the setup request frame, wherein the setup response frame includes an indication of whether dynamic power saving is supported during the service period. When dynamic power saving is supported during the service period, the method may further include triggering the STA during the service period to cause the STA to transition from operating in a low capability mode of a dynamic power saving scheme to operating in a high capability mode of the dynamic power saving scheme.

For purposes of illustration, various embodiments are described herein in the context of wireless networks that are based on IEEE 802.11 standards and using terminology and concepts thereof. Those skilled in the art will appreciate that the embodiments disclosed herein can be modified/adapted for use in other types of wireless networks.

In the following detailed description, only certain embodiments of the present invention have been shown and described, simply by way of illustration. As those skilled in the art would realize, the described embodiments may be modified in different ways, all without departing from the spirit or scope of the present invention. Accordingly, the drawings and description are to be regarded as illustrative in nature and not restrictive. Like reference numerals designate like elements throughout the specification.

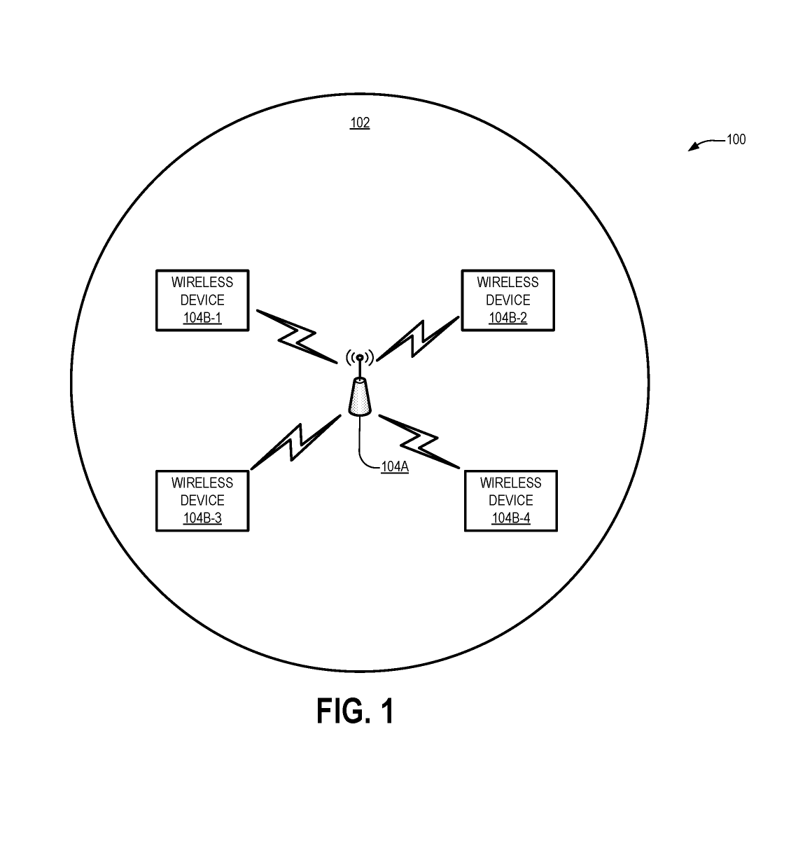

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B₁-104B₄ that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B₁-104B₄) may be collectively referred to as STAs. However, for ease of description, only the non-AP STAs may be referred to as STAs unless the context indicates otherwise. Although shown with four non-AP STAs (e.g., the wireless devices 104B₁-104B₄), the WLAN 100 may include any number of non-AP STAs (e.g., one or more wireless devices 104B).

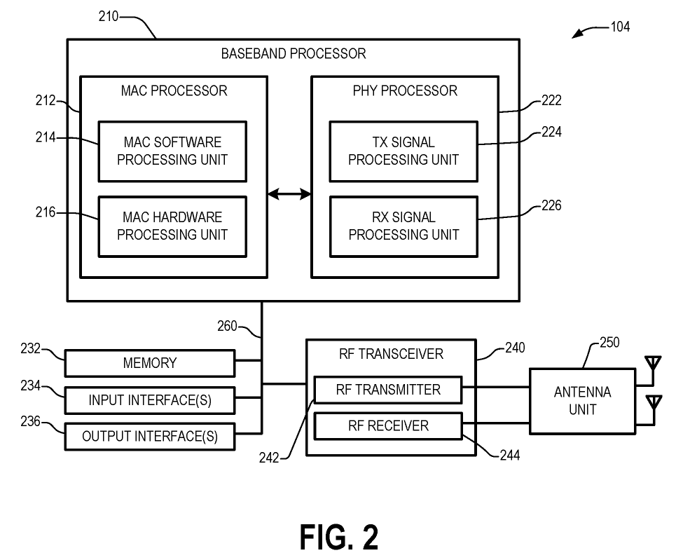

FIG. 2 illustrates a schematic block diagram of a wireless device 104, according to an embodiment. The wireless device 104 may be the wireless device 104A (i.e., the AP of the WLAN 100) or any of the wireless devices 104B₁-104B₄ in FIG. 1. The wireless device 104 includes a baseband processor 210, a radio frequency (RF) transceiver 240, an antenna unit 250, a storage device (e.g., memory device) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in either hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

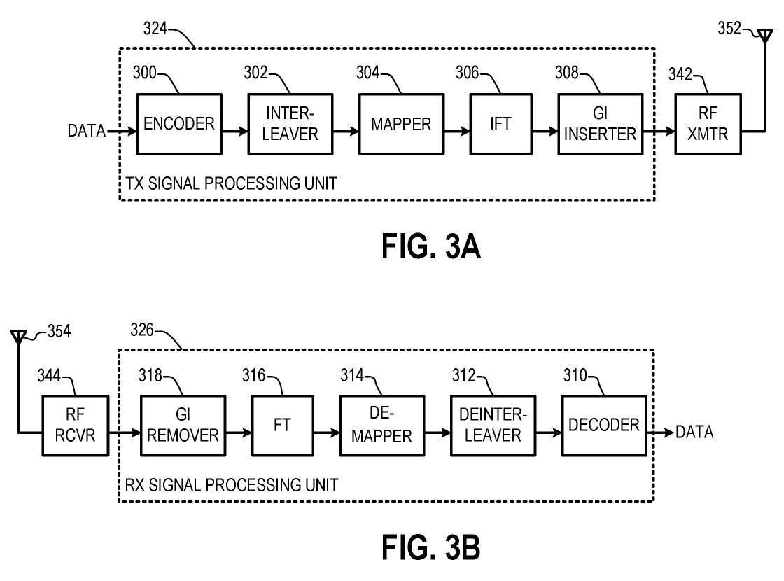

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of 0s or 1s. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) (also referred to as PLCP (Physical Layer Convergence Procedure) Protocol Data Units) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MHz, 80 MHz, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

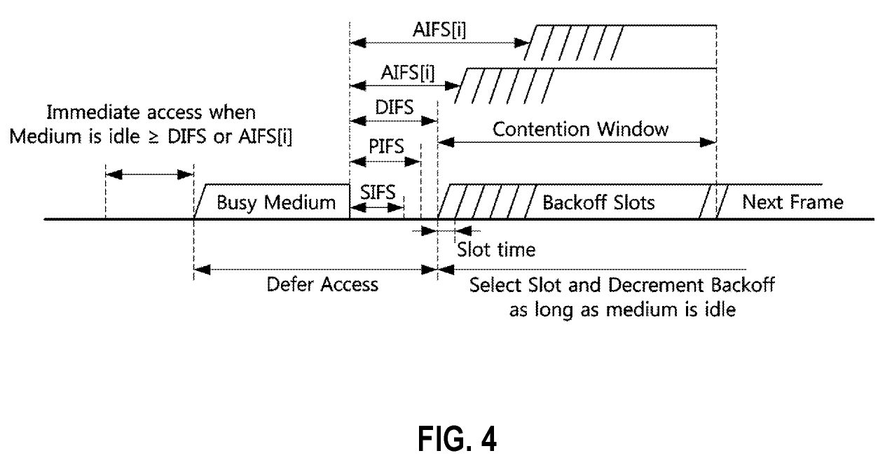

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS[i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QoS) functionality (that is, a QoS STA) may transmit the frame after performing backoff if an AIFS for an associated access category (AC) (i.e., AIFS[AC]) has elapsed. When transmitted by the QoS STA, any of the data frame, the management frame, and the control frame, which is not the response frame, may use the AIFS[AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

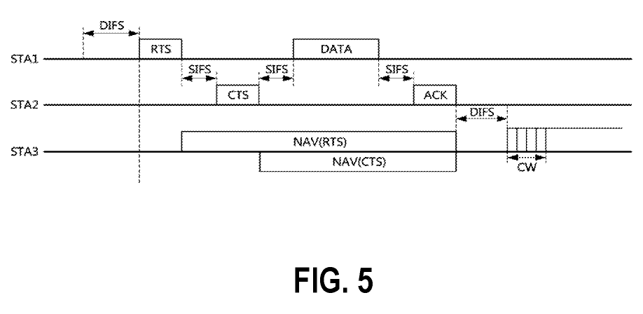

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS + CTS frame duration + SIFS + data frame duration + SIFS + ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 does not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

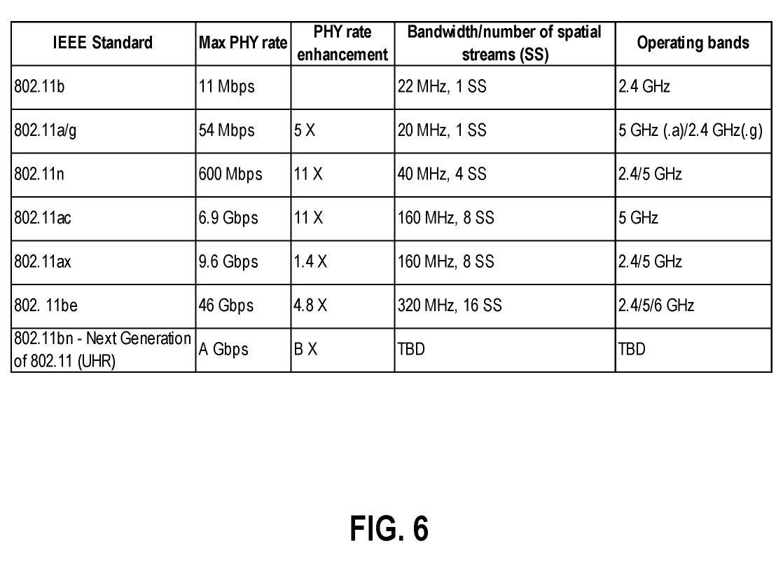

The IEEE 802.11bn (Ultra High Reliability, UHR) working group has been established to address the growing demand for higher peak throughput and reliability in Wi-Fi. As shown in FIG. 6, the peak PHY rate has significantly increased from IEEE 802.11b to IEEE 802.11be (Wi-Fi 7), with the latter focusing on further improving peak throughput. The UHR study group aims to enhance the tail of the latency distribution and jitter to support applications that require low latency, such as video-over-WLAN, gaming, AR, and VR. It is noted that various characteristics of UHR (e.g., max PHY rate, PHY rate enhancement, bandwidth/number of spatial streams, and operating bands) are still to be determined.

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

The focus of IEEE 802.11bn (UHR) is still under discussion, with candidate features including MLO enhancements (e.g., in terms of increased throughput/reliability and decreased latency), latency and reliability improvements (e.g., multi-AP coordination to support low latency traffic), bandwidth expansion (e.g., to 240, 480, 640 MHz), aggregated PPDU (A-PPDU), enhanced multi-link single-radio (eMLSR) extensions to AP, roaming improvements, and power-saving schemes for prolonging battery life.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6 GHz) for IEEE 802.11be, more than 1 GHz of additional unlicensed spectrum is likely to be available because the 6 GHz band (5.925– 7.125 GHz) is being considered for unlicensed use. This would allow APs and STAs to become tri-band devices. Larger than 160MHz data transmissions (e.g., 320 MHz or 640 MHz) could be considered to increase the maximum PHY rate. For example, 320 MHz or 160+160MHz data could be transmitted in the 6 GHz band. For example, 160+160 MHz data could be transmitted across the 5 and 6 GHz bands.

In the process of wireless communication, a transmitting station (STA) creates a Physical Layer Protocol Data Unit (PPDU) frame and sends it to a receiving STA. The receiving STA then receives, detects, and processes the PPDU.

The Extremely High Throughput (EHT) PPDU frame encompasses several components. It includes a legacy part, which comprises fields such as the Legacy Short Training Field (L-STF), Legacy Long Training Field (L-LTF), Legacy Signal Field (L-SIG), and Repeated Legacy Signal Field (RL-SIG). These fields are used to maintain compatibility with older Wi-Fi standards.

In addition to the legacy part, the EHT PPDU frame also contains the Universal Signal Field (U-SIG), EHT Signal Field (EHT-SIG), EHT Short Training Field (EHT-STF), and EHT Long Training Field (EHT-LTF). These fields are specific to the EHT standard and are used for various purposes, such as signaling, synchronization, and channel estimation.

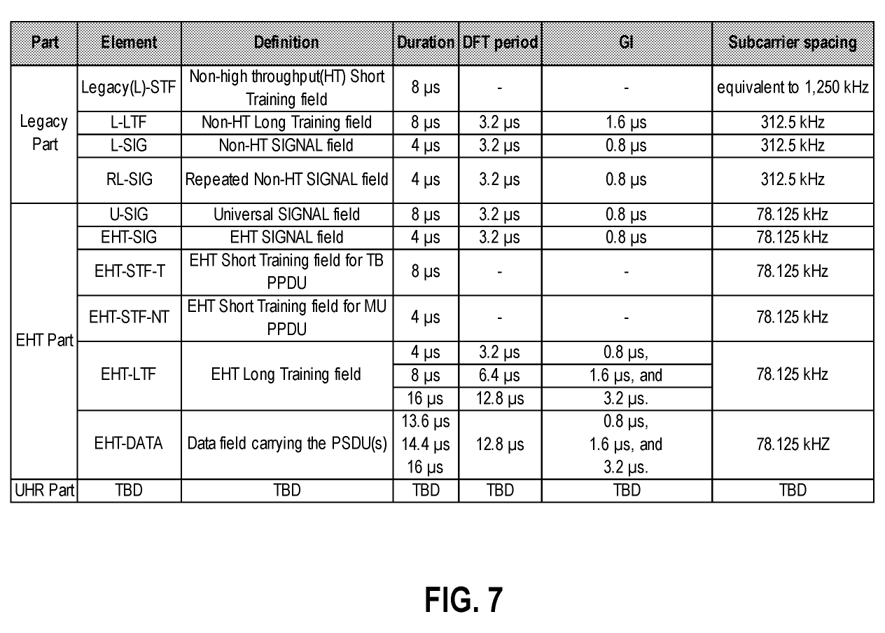

FIG. 7 provides a more detailed description of each field in the EHT PPDU frame, including their purposes and characteristics.

Regarding the Ultra High Reliability (UHR) PPDU, its frame structure is currently undefined and will be determined through further discussions within the relevant working group or study group. This indicates that the specifics of the UHR PPDU are still under development and will be finalized based on the outcomes of future deliberations.

The distributed nature of channel access networks, such as IEEE 802.11 WLANs, makes the carrier sense mechanism useful for ensuring collision-free operation. Each station (STA) uses its physical carrier sense to detect transmissions from other STAs. However, in certain situations, it may not be possible for a STA to detect every transmission. For instance, when one STA is located far away from another STA, it might perceive the medium as idle and start transmitting a frame, leading to collisions. To mitigate this hidden node problem, the network allocation vector (NAV) has been introduced.

As the IEEE 802.11 standard continues to evolve, it now includes scenarios where multiple users can simultaneously transmit or receive data within a basic service set (BSS), such as uplink (UL) and downlink (DL) multi-user (MU) transmissions in a cascaded manner. In these cases, the existing carrier sense and NAV mechanisms may not be sufficient, and modifications or newly defined mechanisms may be required to facilitate efficient and collision-free operation.

For the purpose of this disclosure, MU transmission refers to situations where multiple frames are transmitted to or from multiple STAs simultaneously using different resources. Examples of these resources include different frequency resources in Orthogonal Frequency Division Multiple Access (OFDMA) transmission and different spatial streams in Multi-User Multiple Input Multiple Output (MU-MIMO) transmission. Consequently, downlink OFDMA (DL-OFDMA), downlink MU-MIMO (DL-MU-MIMO), uplink OFDMA (UL-OFDMA), uplink MU-MIMO (UL-MU-MIMO), and OFDMA with MU-MIMO are all considered examples of MU transmission.

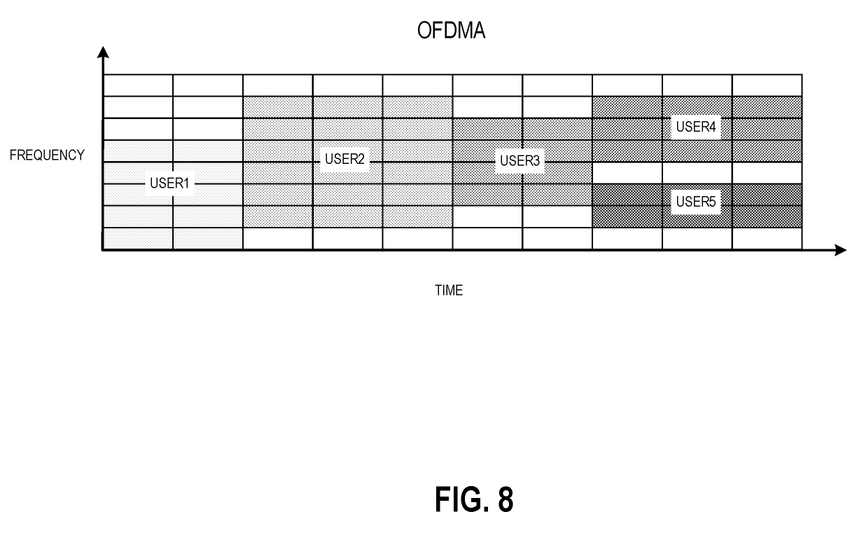

FIG. 8 illustrates an example of multi-user (MU) transmission in Orthogonal Frequency-Division Multiple Access (OFDMA), in accordance with some embodiments of the present disclosure.

In the IEEE 802.11ax and 802.11be specifications, the trigger frame plays a useful role in facilitating uplink multi-user (MU) transmissions. The purpose of the trigger frame is to allocate resources and solicit one or more Trigger-based (TB) Physical Layer Protocol Data Unit (PPDU) transmissions from the associated stations (STAs).

The trigger frame contains information required by the responding STAs to send their Uplink TB PPDUs. This information includes the Trigger type, which specifies the type of TB PPDU expected, and the Uplink Length (UL Length), which indicates the duration of the uplink transmission.

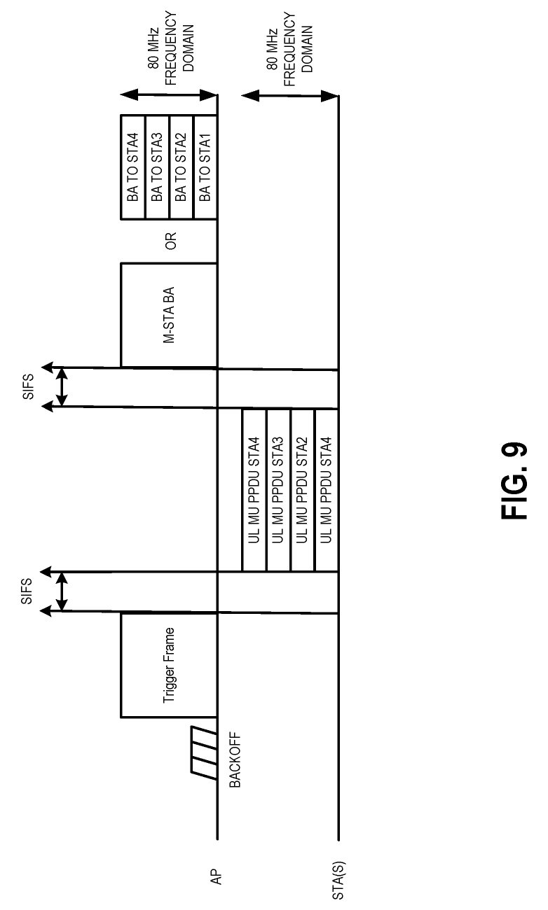

FIG. 9 illustrates an example scenario where an access point (AP) operating in an 80MHz bandwidth environment sends a Trigger frame to multiple associated STAs. Upon receiving the Trigger frame, the STAs respond by sending their respective Uplink Orthogonal Frequency Division Multiple Access (UL OFDMA) TB PPDUs, utilizing the allocated resources within the specified 80 MHz bandwidth.

After successfully receiving the UL OFDMA TB PPDUs, the AP acknowledges the STAs by sending an acknowledgement frame. This acknowledgement can be in the form of an 80MHz width multi-STA Block Acknowledgement (Block Ack) or a Block Acknowledgement with a Direct Feedback (DF) OFDMA method. The multi-STA Block Ack allows the AP to acknowledge multiple STAs simultaneously, while the Block Ack with DF OFDMA enables the AP to provide feedback to the STAs using the same OFDMA technique employed in the uplink transmission.

The trigger frame is a useful component in enabling efficient uplink MU transmissions in IEEE 802.11ax and 802.11be networks, by allocating resources and coordinating the uplink transmissions from multiple STAs within the same bandwidth.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HARQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

AP coordination has been considered as a potential technology to improve WLAN system throughput in the IEEE 802.11be standard and is still being discussed in the IEEE 802.11bn (UHR) standard. To support various AP coordination schemes, such as coordinated beamforming, OFDMA, TDMA, spatial reuse, and joint transmission, a predefined mechanism for APs is necessary.

In the context of coordinated TDMA (Co-TDMA or C-TDMA), the AP that obtains a transmit opportunity (TXOP) is referred to as the sharing AP. This AP initiates the AP coordination schemes to determine the AP candidate set by sending a frame, such as a Beacon frame or probe response frame, which includes information about the AP coordination scheme capabilities. The AP that participates in the AP coordination schemes after receiving the frame from the sharing AP is called the shared AP. The sharing AP is also known as the master AP or coordinating AP, while the shared AP is referred to as the slave AP or coordinated AP.

The operation of various AP coordination schemes has been discussed in the IEEE 802.11be and UHR standards:
Coordinated Beamforming (Co-BF or C-BF): Multiple APs transmit on the same frequency resource by coordinating and forming spatial nulls, allowing for simultaneous transmission from multiple APs.
Coordinated OFDMA (Co-OFDMA or C-OFDMA): APs transmit on orthogonal frequency resources by coordinating and splitting the spectrum, enabling more efficient spectrum utilization.
Joint Transmission (JTX): Multiple APs transmit jointly to a given user simultaneously by sharing data between the APs.
Coordinated Spatial Reuse (Co-SR or C-SR): Multiple APs or STAs adjust their transmit power to reduce interference between APs.

By implementing these AP coordination schemes, WLAN systems can improve their overall throughput and efficiency by leveraging the cooperation between multiple APs.

As used herein, a scheduled power saving scheme is a type of scheme that enables devices to transition between operating in an awake state and a doze/sleep state according to a predefined or negotiated schedule (e.g., having scheduled wake-up times and wake durations). TWT and r-TWT are examples of a scheduled power saving scheme. As used herein, a dynamic power saving scheme is a type of scheme that allows devices to switch between different power consumption modes (e.g., between a high capability mode and a low capability mode) on demand (e.g., via signaling). DPS is an example of a dynamic power saving scheme.

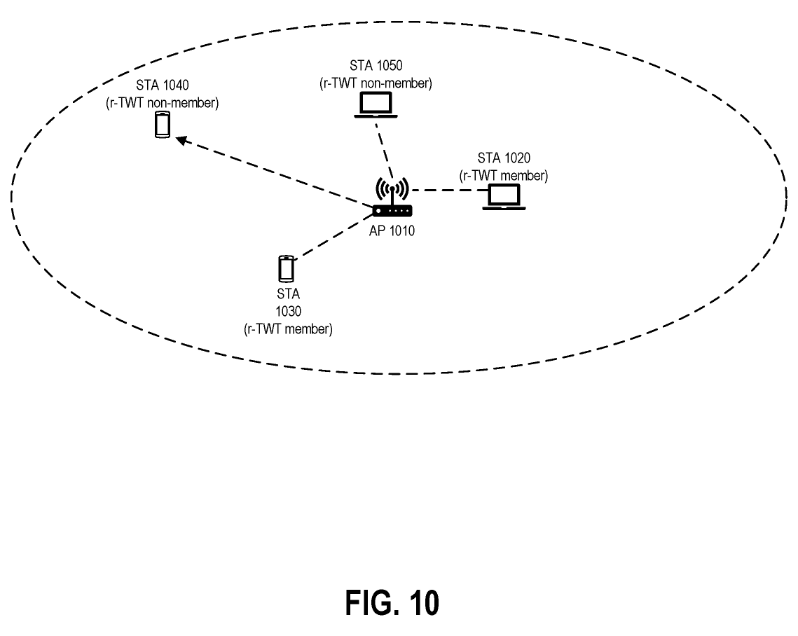

FIG. 10 is a diagram showing a wireless network environment that can implement r-TWT, according to some embodiments.

As shown in the diagram, the wireless network environment may include an AP 1010 and four non-AP STAs that are associated with the AP (STA 1020, STA 1030, STA 1040, and STA 1050). The STAs may be implemented by any type of wireless device such as a mobile device, IoT (Internet of Things) device, or the like.

Each STA may support r-TWT or a similar scheduled power saving scheme. For sake of explanation, it is assumed that the STAs support the r-TWT scheduled power saving scheme. The use of r-TWT may support energy-efficient and latency-aware communications.

In this example, it is assumed that the AP 1010 can manage and schedule a r-TWT SP that is reserved exclusively for member STAs participating in the scheduled r-TWT session. In this example, it is assumed that STA 1020 and 1030 are members of the r-TWT SP, and thus have exclusive access to the channel during the scheduled time window of the r-TWT SP. Also, in this example, it is assumed that the remaining STAs (STA 1040 and STA 1050) are not members of the r-TWT SP. However, these non-member STAs may be capable of recognizing the r-TWT session via beacon frames or other scheduling signals, and thus may be categorized as “r-TWT scheduled STAs.”

As will be described herein, the AP 1010 and the STAs in the wireless network may perform a DPS support negotiation procedure to come to an agreement on whether DPS or similar dynamic power saving scheme will be supported during scheduled r-TWT SPs.

For sake of explanation only, various embodiments may be described herein in the context of the wireless network environment shown in FIG. 10. It should be appreciated, however, that the techniques and concepts described herein may be applicable to other wireless network environments having different configurations/topologies.

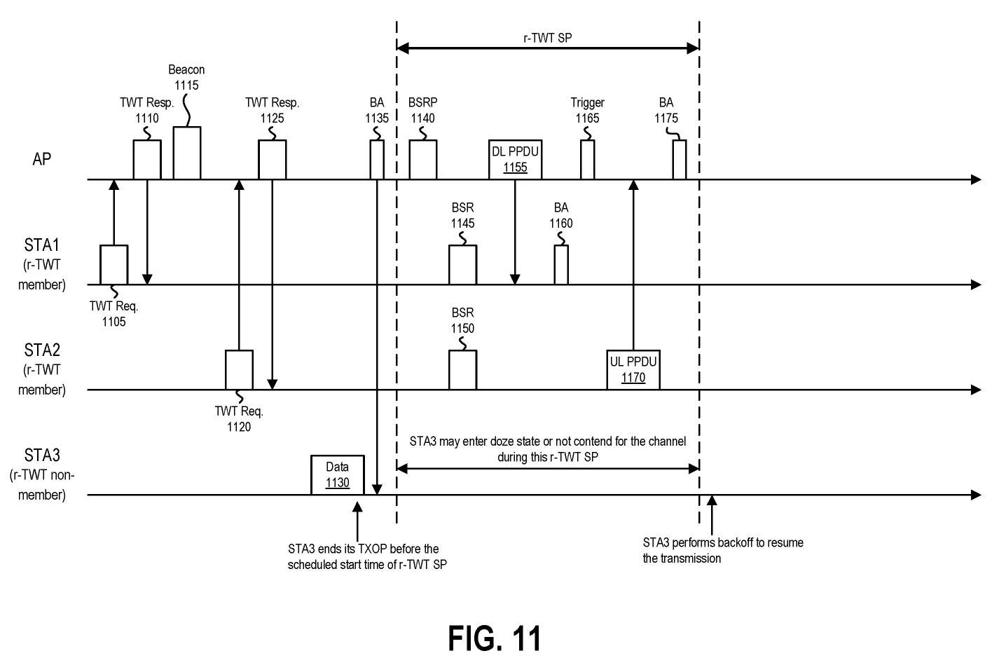

FIG. 11 is a diagram showing a frame exchange sequence for implementing a TWT setup procedure and a r-TWT SP, according to some embodiments.

The frame exchange sequence shown in the diagram, may involve an AP (which may correspond to AP 1010 shown in FIG. 10), a first STA (STA1) that is a member of the r-TWT SP (e.g., STA1 may correspond to STA 1020 shown in FIG. 10), a second STA (STA2) that is also a member of the r-TWT SP (e.g., STA2 may correspond to STA 1030 shown in FIG. 10), and a third STA (STA3) that is not a member of the r-TWT SP (STA3 may correspond to STA 1040 shown in FIG. 10). In this scenario, the AP may act as the r-TWT scheduling entity that coordinates and manages the r-TWT SP and its participating member STAs.

As shown in the diagram, during a TWT setup procedure, STA1 may transmit TWT setup request frame 1105 to the AP to request r-TWT SP membership. Responsive to receiving TWT setup request frame 1105, the AP may transmit TWT setup response frame 1110 to STA1 to indicate that the request has been accepted. STA2 may obtain the r-TWT schedule from a management frame transmitted by the AP such as beacon frame 1115, and transmit its own TWT setup request frame 1120 to the AP to request r-TWT SP membership. Responsive to receiving TWT setup request frame 1120, the AP may transmit TWT setup response frame 1125 to STA2 to indicate that the request has been accepted.

It is assumed in this example that STA3 holds an active transmission opportunity (TXOP) but does not participate in the r-TWT SP membership negotiation. STA3 is aware of the r-TWT schedule and may halt its ongoing transmission and relinquish the TXOP before the r-TWT SP begins. For example, just before the r-TWT SP begins, STA3 may transmit a data frame 1130 to the AP and the AP may respond by transmitting block acknowledgement (BA) frame 1135 to STA3. STA3 may then enter a doze state when the r-TWT SP begins or otherwise not contend for the channel during the r-TWT SP.

During the r-TWT SP, STA1 and STA2, which have been established as members of the r-TWT SP, may engage in prioritized communication with the AP. For example, the AP may transmit buffer status report poll (BSRP) frame 1140 to STA1 and STA2. STA1 and STA2 may respond by transmitting buffer status report (BSR) frame 1145 and BSR frame 1150, respectively, to the AP. The AP may then transmit downlink physical layer protocol data unit (DL PPDU) 1155 to STA1 and STA1 may respond by transmitting BA frame 1160 to the AP. Subsequently, the AP may transmit trigger frame 1165 to STA2 to trigger an uplink transmission from STA2. Responsive to receiving trigger frame 1165, STA2 may transmit uplink physical layer protocol data unit (UL PPDU) 1170 to the AP and the AP may respond by transmitting BA frame 1175 to STA2. As shown in this example, the transmissions during the r-TWT SP may be coordinated through control signaling exchanges (using various types of frames such as BSRP frame, BSR frames, basic trigger frames, and BA frames) to ensure orderly channel access and to confirm successful receptions.

STA3 (which is categorized as a r-TWT scheduled STA in this example) is capable of recognizing the scheduled r-TWT SP based on receiving/overhearing beacon frame 1115 or other scheduling signals, but is prohibited from transmitting during the r-TWT SP. Thus, as shown in the diagram, STA3 may halt/pause any active transmissions/TXOP prior to the start of the r-TWT SP to maintain strict channel isolation for the member STAs. After the r-TWT SP ends, STA3 (which halted/paused its transmission/TXOP just before the start of the r-TWT SP) may reattempt channel access using standard contention-based procedures such as random backoff to attempt to resume its transmission/TXOP.

To enforce strict channel isolation during the r-TWT SP, the AP may broadcast a quiet element that indicates a time period during which all receiving STAs (particularly non-member STAs such as STA3) should remain silent. Upon receiving this indication, non-member STAs (e.g., STA3) may enter a doze state or otherwise refrain from initiating new transmissions during the indicated time period to ensure that the channel remains interference-free for the r-TWT SP member STAs.

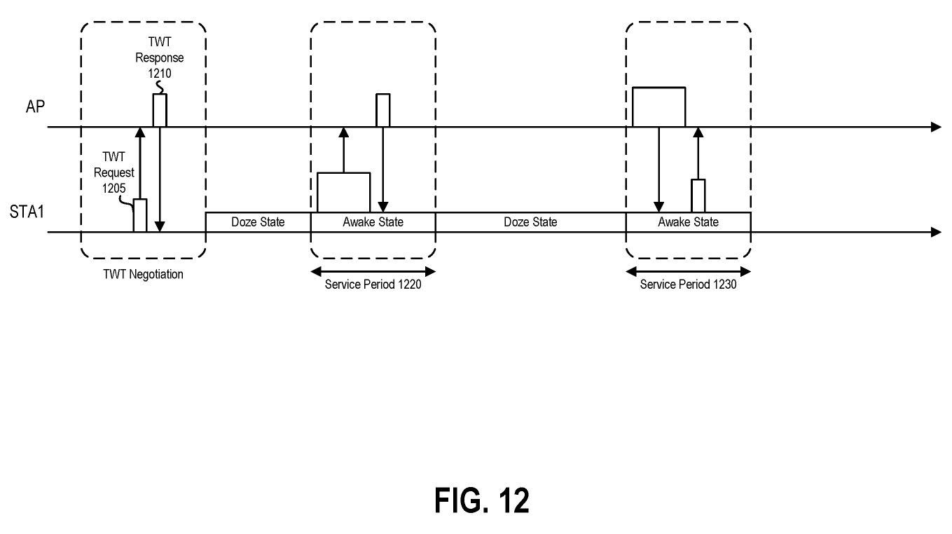

FIG. 12 is a diagram showing a TWT negotiation procedure, according to some embodiments.

The diagram shows a TWT negotiation procedure that allows an AP and a STA to establish a wake-up schedule for improved energy-efficiency and optimized channel utilization. TWT may provide two types of TWTs: 1) broadcast TWT; and 2) individual TWT. With broadcast TWT, the AP defines a shared wake-up schedule for multiple STAs and transmits a beacon frame announcing the wake-up schedule to allow the STAs to synchronize their transmissions. In contrast, with individual TWT, a STA and an AP directly negotiate a customized wake-up schedule with each other. The TWT negotiation procedure shown in the diagram is an example of negotiating an individual TWT.

As shown in the diagram, STA1 may initiate the TWT negotiation procedure by transmitting TWT setup request frame 1205 to the AP and the AP may respond by transmitting TWT setup response frame 1210 to STA1. TWT setup response frame 1210 may specify the parameters for the scheduled wake-up periods (e.g., the schedule of the SPs). Once the negotiation is complete, STA1 may operate according to the agreed-upon wake-up schedule, alternating between being in the awake state and the doze state to conserve power. In this example, it is assumed that the TWT negotiation resulted in the scheduling of SP 1220 and SP 1230.

Existing TWT implementations assume that a STA always remains in the awake state and operates at full capacity during the entire duration of a scheduled SP. That is, once the STA wakes up for a scheduled SP, it is expected to function with full transmission and reception capability until the SP is over.

For example, as shown in the diagram, STA1 (which may correspond to STA 1020 shown in FIG. 10) may leave the doze state and enter the awake state at the beginning of a scheduled r-TWT SP 1220. STA1 may stay in the awake state for the entire duration of SP 1220 and exchange frames with the AP during this SP 1220. STA1 may enter the doze state when SP 1220 ends. STA1 may then again leave the doze state and enter the awake state at the beginning of the next scheduled SP 1230. STA1 may stay in the awake state for the entire duration of SP 1230 and exchange frames with the AP during this SP 1230.

The TWT negotiation procedure may allow multiple STAs to negotiate their own individual/customized wake-up schedules, ensuring efficient coordination of transmissions in dense wireless network environments. The use of TWT allows STAs to conserve power while still maintaining reliable communication with the AP.

An AP and a STA may use various TWT setup commands to negotiate the TWT parameters, some of which are described herein below.

Request TWT (STA → AP): The STA leaves the specific TWT parameters flexible, allowing the AP to determine them.

Accept TWT (AP → STA): The AP approves the proposed TWT agreement and finalizes the TWT session parameters.

Suggest TWT (STA → AP): The STA proposes preferred TWT parameters but is open to further negotiation.

Alternate TWT (AP → STA): The AP counter-proposes alternative TWT parameters without finalizing the TWT agreement yet.

Demand TWT (STA → AP): The STA insists on strict adherence to its specified TWT parameters.

Dictate TWT (AP → STA): The AP rejects the initial setup but suggests TWT parameters under which an agreement could be reached if the STA resubmits its request.

Reject TWT (AP → STA): The AP denies the TWT session establishment, requiring the STA to restart the TWT negotiation procedure.

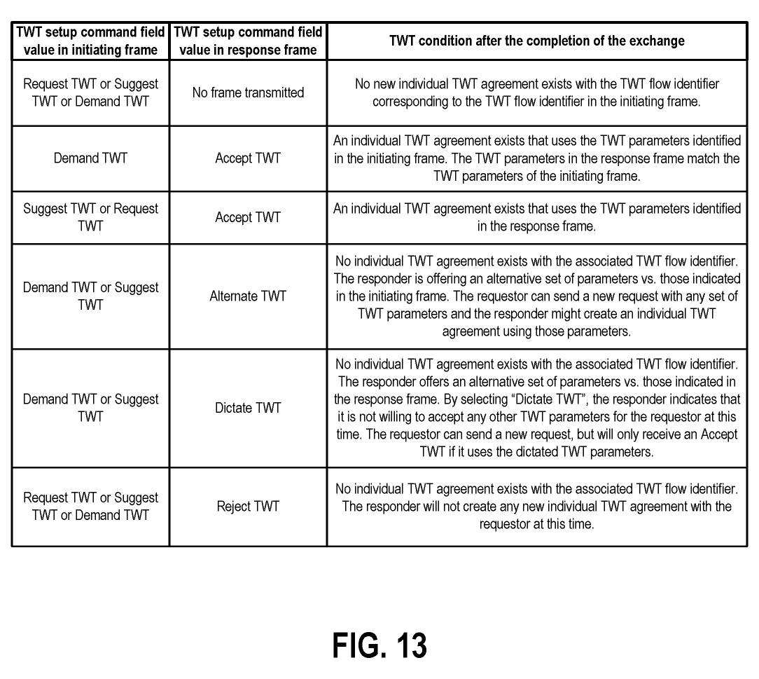

FIG. 13 is a table showing a summary of the TWT conditions after certain TWT setup command exchanges, according to some embodiments.

Each row in the table corresponds to a different TWT setup command exchange. The first column in the table indicates the TWT setup command field value in the initiating/request frame (e.g., the TWT setup request frame). The second column in the table indicates the TWT setup command field value in the response frame (e.g., the TWT setup response frame). The third column in the table indicates the TWT condition after the completion of the corresponding TWT setup command exchange.

As shown in the table, if the initiating frame includes a request, suggest, or demand TWT setup command and no response frame is transmitted, the resulting TWT condition is that no new individual TWT agreement exists with the TWT flow identifier corresponding to the TWT flow identifier in the initiating frame. If the initiating frame includes a demand TWT setup command and the response frame includes an accept TWT setup command, the resulting TWT condition is that an individual TWT agreement exists that uses the TWT parameters identified in the initiating frame. The TWT parameters in the response frame match the TWT parameters of the initiating frame. If the initiating frame includes a suggest or request TWT setup command and the response frame includes an accept TWT setup command, the resulting TWT condition is that an individual TWT agreement exists that uses the TWT parameters identified in the response frame. If the initiating frame includes a demand or suggest TWT setup command and the response frame includes an alternate TWT setup command, the resulting TWT condition is that no individual TWT agreement exists with the associated TWT flow identifier. The responder is offering an alternative set of parameters compared to those indicated in the initiating frame. The requestor can send a new request with any set of TWT parameters and the responder might create an individual TWT agreement using those parameters. If the initiating frame includes a demand or suggest TWT setup command and the response frame includes a dictate TWT setup command, the resulting TWT condition is that no individual TWT agreement exists with the associated TWT flow identifier. The responder offers an alternative set of parameters compared to those indicated in the response frame. By selecting the dictate TWT setup command (“Dictate TWT”), the responder indicates that it is not willing to accept any other TWT parameters from the requestor at this time. The requestor can send a new request, but will only receive an acceptance (accept TWT setup command) if it uses the dictated TWT parameters. If the initiating frame includes a request, suggest, or demand TWT setup command and the response frame includes a reject TWT setup command, the resulting TWT condition is that no individual TWT agreement exists with the associated TWT flow identifier. The responder will not create any new individual TWT agreement with the requestor at this time.

During the TWT setup phase, the AP and the STA may negotiate two critical parameters to optimize wake-up behavior: the next target beacon parameter and the listen interval parameter. The next target beacon parameter may indicate the timing of the next beacon frame transmission that contains the TWT session details, allowing the STA to prepare for upcoming transmissions. The listen interval parameter may indicate the periodicity with which such beacon frames will be transmitted (possibly with updated TWT-related information).

After successful negotiation of the TWT parameters, the STA may enter a doze state to conserve energy and only wake up when the next scheduled beacon frame is transmitted. These beacon frames ensure that all participating STAs remain synchronized with the broadcast TWT schedule. Also, the AP may update the TWT parameters via the beacon frames, if necessary, which allows for maintaining flexibility and adaptability within the wireless network in terms of the TWT schedule.

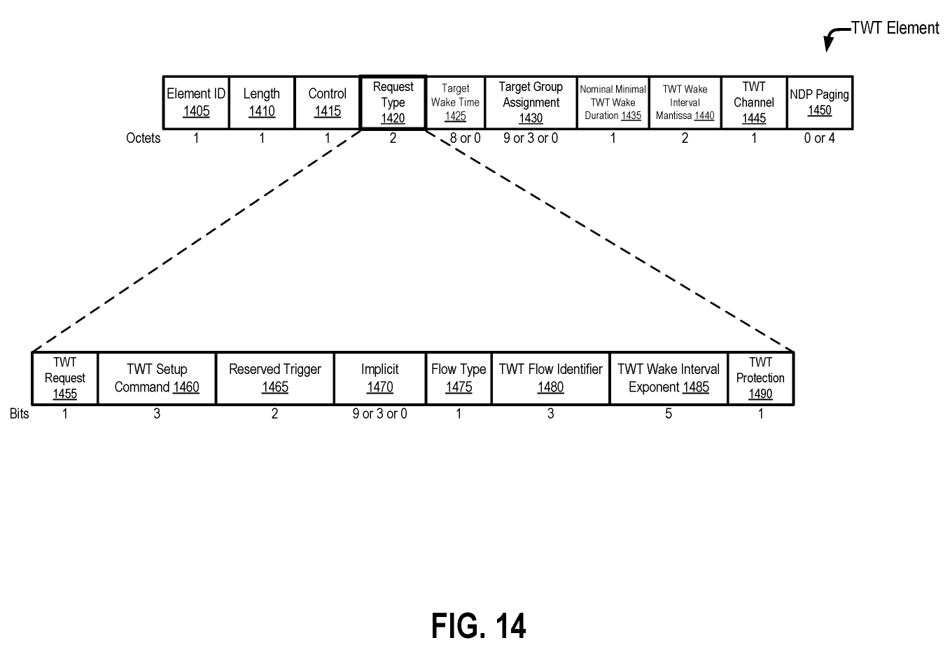

FIG. 14 is a diagram showing TWT element format, according to some embodiments.

A TWT element may specify the key TWT parameters for managing the duty cycle of wake-up periods. The TWT element may be included in the TWT setup request frames and TWT setup response frames as part of the TWT negotiation procedure. The TWT parameters may be negotiated/configured to determine the scheduled wake-up times/schedules for STAs.

As shown in the diagram, the TWT element may include an element ID field 1405 (1 octet), a length field 1410 (1 octet), a control field 1415 (1 octet), a request type field 1420 (2 octets), a target wake time field 1425 (8 or 0 octets), a target group assignment field 1430 (9 or 3 or 0 octets), a nominal minimal TWT wake duration field 1435 (1 octet), a TWT wake interval mantissa field 1440 (2 octets), a TWT channel field 1445 (1 octet), and a null data packet (NDP) paging field 1450 (0 or 4 octets).

As shown in the diagram, the request type field 1420 may include a TWT request field 1455 (1 bit), a TWT setup command field 1460 (3 bits), a reserved trigger field 1465 (2 bits), an implicit field 1470 (9 or 3 or 0 bits), a flow type field 1475 (1 bit), a TWT flow identifier field 1480 (3 bits), a TWT wake interval exponent field 1485 (5 bits), and a TWT protection field 1490 (1 bit).

The target wake time field 1425 may indicate the exact time at which a STA is scheduled to wake for the first communication instance under the TWT agreement. This enables precise synchronization between the AP and STA, ensuring predictable and efficient operation.

The TWT wake interval mantissa field 1440 and the TWT wake interval exponent field 1485 may together indicate the TWT wake interval. The TWT wake interval may define how frequently a STA should wake up to communicate with the AP (e.g., the interval between two consecutive wake-ups). These fields may be configurable to allow the wake-up intervals to be flexibly adjusted to accommodate different traffic patterns and power saving requirements.

The nominal minimal TWT wake duration field 1435 may indicate the minimum TWT wake duration. The minimum TWT wake duration may define the minimum time that a STA must remain in the awake state after the start of a SP. The STA is expected to stay in the awake state for at least the minimum TWT wake duration to enable the STA to communicate with the AP or other STAs before entering the doze state to conserve power. By ensuring that STAs remain awake for at least a predefined minimum duration, the wireless network guarantees that essential communications can be processed while still providing power-saving benefits.

Thus, the TWT wake interval may control how frequently STAs wake up, while the minimum TWT wake duration may ensure that STAs remain awake long enough to process essential communications.

The request type field 1420, the target wake time field 1425, the target group assignment field 1430, the nominal minimal TWT wake duration field 1435, the TWT wake interval mantissa field 1440, the TWT channel field 1445, and the null data packet (NDP) paging field 1450 may be included in a TWT parameter set field within an IEEE 802.11 TWT element. The TWT parameter set field may be used during the TWT negotiation procedure. When a STA initiates a TWT setup with the AP, the TWT parameter set field may indicate the negotiation mode and/or preferences (e.g., in the request type field 1420). Based on these parameters, the AP may accept, suggest modifications, or reject the TWT proposal (e.g., using the TWT setup commands described above).

The values carried in the TWT element can be adjusted to help minimize unnecessary power usage while maintaining service/communication reliability, which is important for modern wireless networks that often need to support both latency-sensitive and energy-constrained devices.

For sake of brevity, only certain fields of the TWT element that are deemed to be relevant to the understanding of embodiments are described in detail herein. The other fields of the TWT element can be interpreted as functioning in accordance with IEEE 802.11 wireless networking standards.

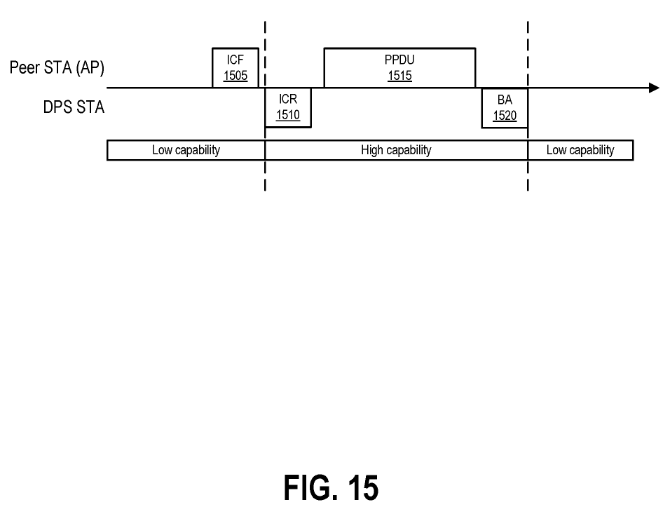

FIG. 15 is a diagram showing DPS operations, according to some embodiments.

DPS may allow a STA to dynamically alternate between operating in the low capability mode and the high capability mode, as needed. DPS is designed to optimize energy efficiency by allowing a STA to remain in the low capability mode until higher transmission capacity is required. When DPS is enabled, a STA may operate in the low capability mode most of the time to conserve energy. When a peer STA such as an AP needs to initiate a frame exchange or TXOP, it may transmit an initial control frame (ICF) 1505 to the DPS-enabled STA to cause the STA to transition from operating in the low capability mode to operating in the high capability mode. The initial control frame 1505 serves to instruct the DPS-enabled STA to switch DPS modes to support a higher data transmission rate.

Upon receiving the initial control frame 1505, the DPS-enabled STA may respond by transmitting an initial control response frame 1510 (ICR) to confirm that it has transitioned (or will transition) to operating in the high capability mode. The initial control frame 1505 may include padding to ensure that the DPS-enabled STA has sufficient time to transition to operating in the high capability mode. Since the DPS-enabled STA needs to successfully interpret the initial control frame 1505 before making the transition, an intermediate frame check sequence (FCS) field may be included in the initial control frame 1505 before the padding. This intermediate FCS field may allow the DPS-enabled STA to verify the initial control frame's 1505 integrity early and start the DPS mode transition early.

Once the DPS-enabled STA finishes transitioning to operating in the high capability mode, it can operate at full capacity for data transmission and reception. For example, as shown in the diagram, while the DPS-enabled STA operates in the high capability mode, the AP may transmit PPDU 1515 to the DPS-enabled STA and the DPS-enabled STA may respond by transmitting BA frame 1520 to the AP. After the frame exchange ends, the DPS-enabled STA may transition back to operating in the low capability mode to conserve energy until another high-capacity transmission is needed.

Thus, DPS can dynamically balance energy savings and performance by allowing STAs to operate in a low capability mode and only transition to operating in the high capability mode when necessary.

The present disclosure describes an enhancement to the TWT setup procedure to integrate a DPS support negotiation mechanism into the procedure. Additional DPS-related fields can be included in the TWT setup request frame and/or the TWT setup response frame to negotiate DPS support (i.e., to negotiate whether DPS operations are allowed during SPs). For example, the TWT setup request frame transmitted by a STA may include a DPS support request field to request that DPS be supported during a SP. Also, the TWT setup response frame transmitted by the AP (with a setup command of accept, alternate, or dictate TWT setup command) may include a DPS support response field to indicate whether DPS is supported during a SP. The DPS support request field and DPS support response field may be generally referred to herein as DPS support fields.

During the TWT negotiation procedure, a STA may explicitly indicate its intent to use DPS when establishing either an individual or group TWT session. Based on system policies and the characteristics of the SP, the AP may respond by explicitly indicating whether DPS usage is permitted during the SP.

The DPS support request/response fields may be integrated into various types of frame exchanges, including but not limited to, association request/response frames, re-association request/response frames, relay setup request frames, and standalone TWT setup frames.

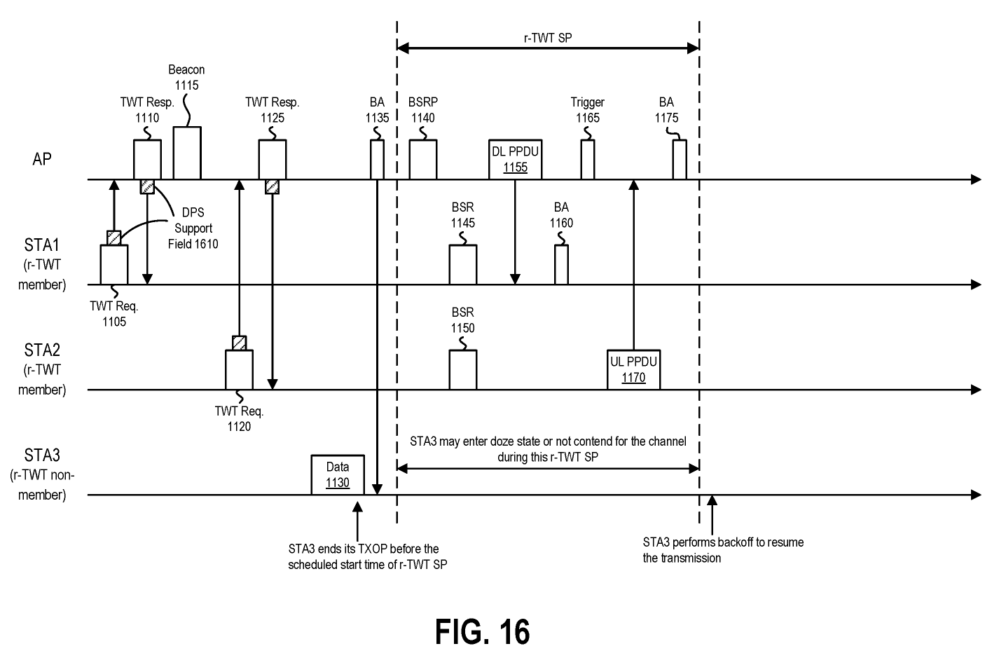

FIG. 16 is a diagram showing a TWT setup procedure that integrates DPS support negotiation, according to some embodiments.

As shown in the diagram, the TWT setup procedure may be similar to the procedure shown in FIG. 11 except that STA1 may insert a DPS support request field in the TWT setup request frame 1105 that it transmits to the AP to indicate STA1’s willingness to use DPS during the r-TWT SP. Also, the AP may insert a DPS support response field in the TWT setup response frame 1110 it transmits to STA1 to indicate whether the use of DPS is allowed during the r-TWT SP. This DPS support request field and DPS support response field are depicted in the diagram as shaded boxes labeled as DPS support fields 1610. Similarly, STA2 may insert a DPS support request field in the TWT setup request frame 1120 that it transmits to the AP to indicate STA2’s willingness to use DPS during the r-TWT SP and the AP may insert a DPS support response field in the TWT setup response frame 1125 it transmits to STA2 to indicate whether the use of DPS is allowed during the r-TWT SP. The remaining operations may be similar to the operations shown in FIG. 11 and described in relation thereto, except that the use of DPS may be allowed (or disallowed) during the r-TWT SP depending on the results of the negotiations.

The DPS support negotiation mechanism described herein may be enabled by introducing a new DPS support field in the TWT element and by extending the TWT setup procedure to support DPS support negotiation. These aspects are described in further detail herein below.

### 1 Introduction of the DPS Support Field in the TWT element

To enable DPS support negotiation during the TWT setup procedure, multiple design options can be considered for signaling DPS support (or lack of support). Two implementation options are described herein by way of example. The first option is to add a new field to the TWT element to signal DPS support and the second option is to use reserved bits in the broadcast TWT parameter set field to signal DPS support.

### Option 1: Addition of a New Field to the TWT Element

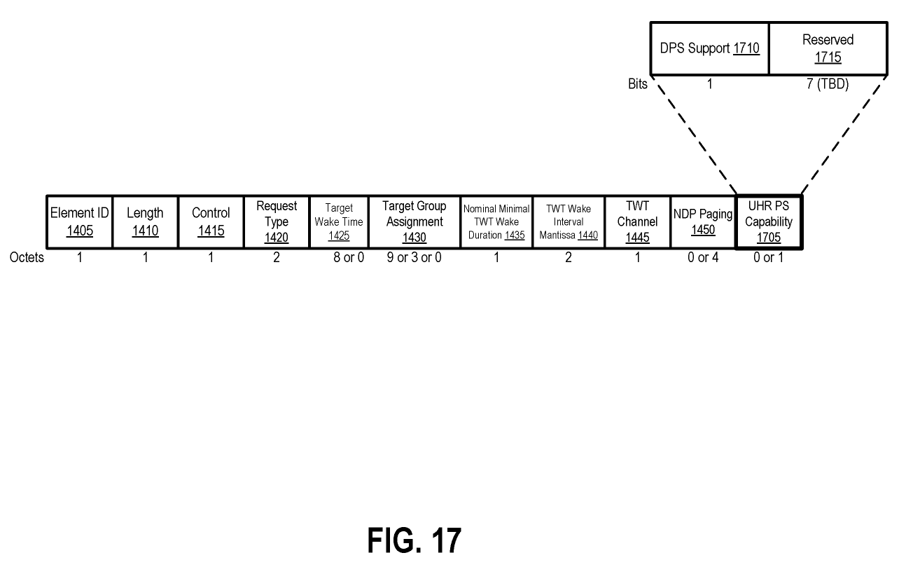

FIG. 17 is a diagram showing a TWT element format that includes a new UHR power save capability field to signal DPS support, according to some embodiments.

As shown in the diagram, the TWT element may include the same fields shown in FIG. 14 and described in relation thereto, but also include a new UHR power save (PS) capability field 1705 (0 or 1 octets).

The UHR PS capability field 1705 (1 octet in length) may include a DPS support field 1710 that a STA can use to indicate that support for DPS is being requested or that an AP can use to indicate whether DPS is supported during a r-TWT SP. The UHR PS capability field 1705 may also include a reserved field 1715 (7 bits or a to be determined (TBD) length) to carry information regarding other power management features or vendor-specific enhancements, while maintaining backward compatibility.

### Option 2: Use of Reserved Bits in the Broadcast TWT Parameter Set Field

As an alternative to extending the TWT element, in an embodiment, a 1-bit DPS support field may be introduced by repurposing one of the unused bits in a reserved portion of the TWT element. The rest of the reserved field may remain unmodified to preserve backward compatibility. This option offers a lightweight and efficient approach for conveying DPS support information without introducing additional protocol overhead.

For example, as will be described in additional detail herein, in scenarios involving broadcast TWT or restricted TWT (r-TWT) operations, the reserved bit(s) within the restricted TWT traffic info field may encode such information.

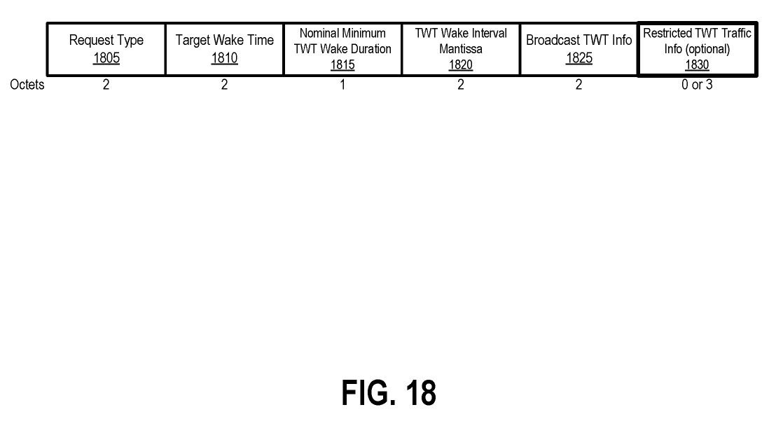

FIG. 18 is a diagram showing a broadcast TWT parameter set field format, according to some embodiments. The broadcast TWT parameter set field may be included within the TWT element. Specifically, when the broadcast bit (e.g., the most significant bit (MSB) of the negotiation type field included in the control field 1415) is set to binary “1”, a TWT parameter information field of the TWT element may include one or more broadcast TWT parameter set fields.

As shown in the diagram, the broadcast TWT parameter set field may include a request type field 1805 (2 octets), a target wake time field 1810 (2 octets), a nominal minimum TWT wake duration field 1815 (1 octet), a TWT wake interval mantissa field 1820 (2 octets), a broadcast TWT info field 1825 (2 octets), and an optional restricted TWT traffic info field 1830 (0 or 3 octets).

A 1-bit DPS support field can be defined within the reserved portion of the restricted TWT traffic info field 1830 to indicate whether DPS-related features such as a DPS-enabled r-TWT SPs are supported or expected by the wireless network. For example, an AP may set this bit (e.g., to binary “1”) to indicate that DPS will be supported (DPS operations are permitted) during the corresponding r-TWT SPs, and that the member STAs should adapt their power behavior accordingly.

This DPS support signaling approach may be particularly advantageous in group-based scheduling environments, where individual TWT element modifications may be impractical. Embedding DPS support signaling within the broadcast TWT parameter set field may enable the AP to flexibly manage and coordinate power-saving behavior across multiple STAs, without altering per-STA TWT negotiation mechanisms.

Thus, this DPS support signaling approach may provide a scalable and minimally invasive mechanism to enable dynamic power management in a manner that aligns with existing frame structures, while also providing the flexibility needed for future extensions.

### 2 Extension of the TWT Setup Procedure to Support DPS Support Negotiation

Building upon the introduction of the DPS support field, in an embodiment, the TWT setup procedure can be extended to integrate a DPS support negotiation mechanism into the TWT setup request and TWT setup response frames.

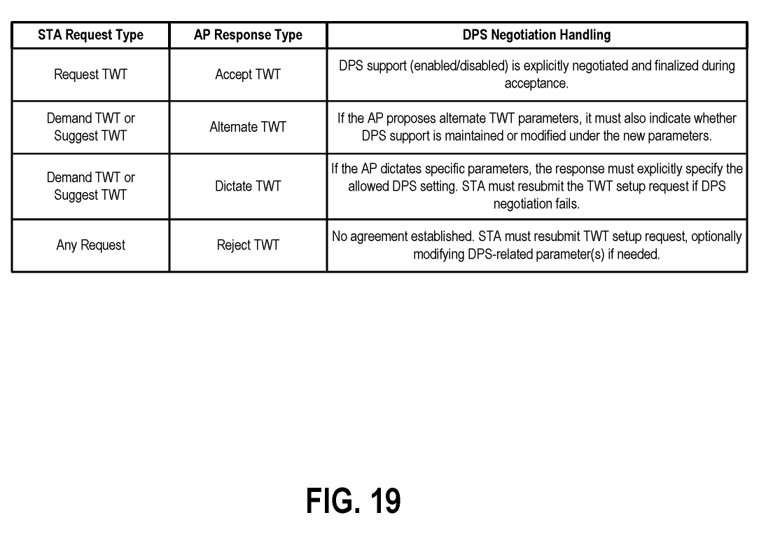

FIG. 19 is a table showing a summary of DPS support negotiation handling for certain TWT setup command exchanges, according to some embodiments.

The table summarizes the DPS support negotiation handling for certain TWT setup command exchanges. Each row in the table corresponds to a different TWT setup command exchange. The first column in the table indicates the STA request type (the TWT setup command) and the second column in the table indicates the AP response type (the TWT setup command). The third column in the table indicates the DPS negotiation handling for the corresponding TWT setup command exchange. As shown in the table, depending on the type of TWT setup request initiated by the STA and the corresponding response by the AP, the DPS negotiation may proceed as follows.

Request TWT – Accept TWT: When the AP accepts the TWT setup request, the DPS support option (enabled/disabled) is explicitly negotiated and finalized as part of the acceptance.

Demand TWT or Suggest TWT – Alternate TWT: If the STA demands or suggests TWT parameters and the AP responds with alternate TWT parameters, the AP must also indicate whether DPS support is maintained or modified under the newly proposed TWT parameters.

Demand TWT or Suggest TWT – Dictate TWT: When the STA demands or suggests specific TWT parameters and the AP dictates the setup, the AP must explicitly specify whether DPS is supported or not. If DPS support negotiation fails, the STA is required to resubmit the TWT setup request.

Any Request – Reject TWT: If the AP rejects the TWT setup request, no agreement is established. The STA must resubmit the TWT setup request, optionally updating DPS-related parameters as needed.

This negotiation approach ensures that DPS support is consistently negotiated and agreed upon during the TWT setup procedure, providing a foundation for efficient power-saving operations.

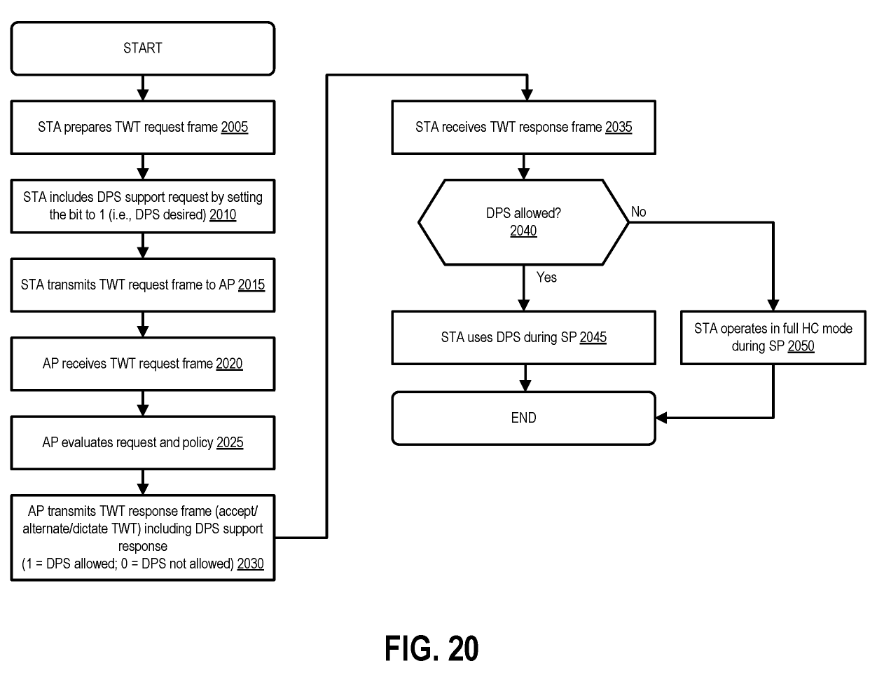

FIG. 20 is a flow diagram of a TWT setup procedure that integrates DPS support negotiation, according to some embodiments.

As shown in the diagram, at operation 2005, the STA may prepare a TWT setup request frame that includes a DPS support request field. At operation 2010, the STA may include a DPS support request by setting the bit in the DPS support request field to binary “1” (if DPS support is desired).

At operation 2015, the STA may transmit the TWT setup request frame to the AP.

At operation 2020, the AP may receive the TWT setup request frame from the STA. At operation 2025, the AP may process the received TWT setup request frame, including the DPS support request field, and evaluate the request based on system/network policies to determine whether DPS usage should be allowed during the r-TWT SP.

At operation 2030, the AP may transmit a TWT setup response frame that includes a DPS support response field indicating whether DPS usage is allowed during the r-TWT SP (e.g., the DPS support response field may carry a value of binary “1” if DPS usage is allowed or carry a value of binary “0” if DPS usage is not allowed). If DPS usage is allowed, the TWT setup response frame may include an accept/alternate/dictate TWT setup command, an indication of the accepted or modified TWT parameters, and a DPS support response field indicating that DPS usage is allowed. If DPS usage is not allowed, the AP may prepare a TWT setup response frame that either rejects the request (by including a reject TWT setup command) or propose new parameters without allowing DPS usage.

At operation 2035, the STA may receive the TWT setup response frame from the AP. At operation 2040, the STA may examine the negotiated TWT parameters and the DPS support status. If the negotiation is successful and DPS usage is allowed, the procedure may proceed to operation 2045, at which the STA proceeds to use DPS during the r-TWT SP. Otherwise, if DPS usage is not allowed, the procedure may proceed to operation 2050, at which the STA operates in the high capability mode during the entire duration of the r-TWT SP. If the negotiation fails, the STA may transmit a new TWT setup request frame to initiate a new negotiation, if needed. The TWT negotiation procedure concludes once agreement is reached or negotiations are terminated.

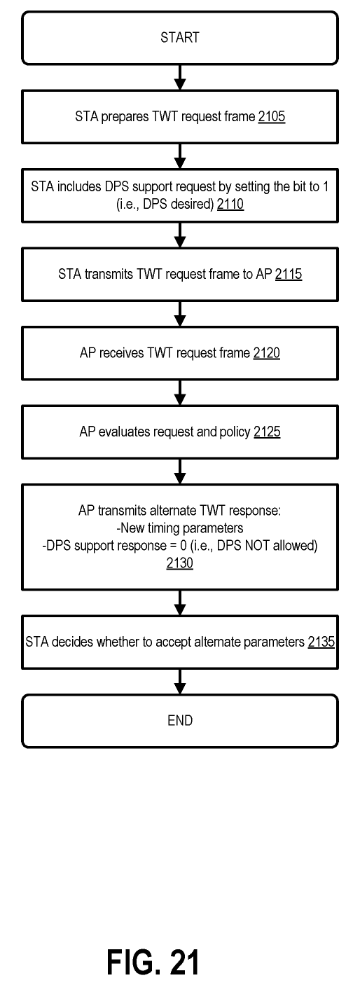

FIG. 21 is a flow diagram of a TWT setup procedure where an AP modifies the DPS support setting, according to some embodiments.

The TWT setup procedure shown in the diagram is an example where the AP responds with alternate TWT parameters and proposes disabling DPS support.

As shown in the diagram, at operation 2105, the STA may prepare a TWT setup request frame. At operation 2110, the STA may include a DPS support request field in the TWT setup request frame to indicate that the STA is requesting that DPS be supported (allow DPS operations) during the r-TWT SP (e.g., by setting a bit included in the DPS support request field to binary “1”). At operation 2115, the STA may transmit the TWT setup request frame (including the DPS support request field) to the AP.

At operation 2120, the AP may receive the TWT setup request frame from the STA. At operation 2125, the AP may evaluate the request (e.g., which may include analyzing both the requested TWT parameters and the DPS support request) based on policy. In this example, it is assumed that the AP determines that DPS should not be supported during the r-TWT SP (DPS operations should not be allowed) based on the current network conditions or policy. Thus, at operation 2130, instead of rejecting the request, the AP may transmit an alternate TWT setup response that proposes new timing parameters and that includes a DPS support response field indicating that DPS is not supported during the r-TWT SP (e.g., by setting a bit included in the DPS support response field to binary “0”).

At operation 2135, the STA may receive the alternate TWT setup response frame from the AP and decide whether to accept the new/alternate timing parameters and the modified DPS support setting. If the STA accepts the proposed parameters and the modified DPS support setting (i.e., DPS is disabled), the negotiation is successful and the procedure may end.

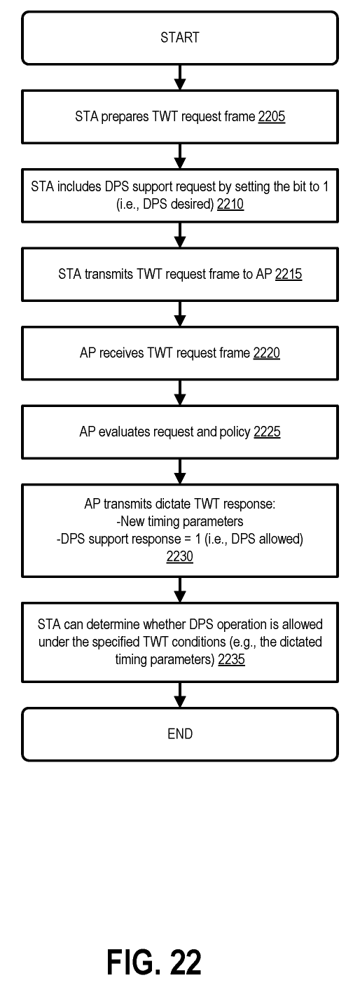

FIG. 22 is a diagram showing a TWT setup procedure where an AP dictates the DPS support setting, according to some embodiments.

The TWT setup procedure shown in the diagram is an example where the AP dictates specific TWT parameters and dictates that DPS be supported during the r-TWT SP.

As shown in the diagram, at operation 2205, the STA may prepare a TWT setup request frame. At operation 2210, the STA may include a DPS support request field in the TWT setup request frame to indicate that the STA is requesting that DPS be supported during the r-TWT SP (e.g., by setting a bit included in the DPS support request field to binary “1”). At operation 2215, the STA may transmit the TWT setup request frame (including the DPS support request field) to the AP.

At operation 2220, the AP may receive the TWT setup request frame from the STA. At operation 2225, the AP may evaluate the request (e.g., which may include analyzing both the requested TWT parameters and the DPS support request) based on system/network policy. In this example, it is assumed that the AP determines that it will dictate specific TWT parameters for the TWT session and dictate that DPS be supported during the r-TWT SP (dictate that DPS operations are allowed during the SP). Thus, at operation 2230, the AP may transmit a dictate TWT setup response that includes the dictated timing parameters and a DPS support response field indicating that DPS is to be supported during the r-TWT SP (e.g., by setting a bit included in the DPS support response field to binary “1”).

At operation 2235, the STA may process the dictated TWT parameters and determine that DPS is to be supported during the r-TWT SP.

The DPS support negotiation mechanism described herein integrates DPS support negotiation into the TWT setup procedure. The DPS support negotiation mechanism may offer one or more of the following technological advantages.

The DPS support negotiation mechanism may enable a more flexible and efficient power management strategy tailored to r-TWT for individual and/or group TWT sessions. By explicitly negotiating DPS support during the TWT setup phase, the STA and AP can align their power-saving expectations upfront, thereby reducing potential misalignment between device capabilities/expectations and network policies. This pre-coordination eliminates the need for additional signaling or renegotiation during active TWT sessions, leading to reduced control overhead and more stable operational behavior.

The DPS support negotiation mechanism may allow seamless support for heterogeneous devices with varying power-saving needs and capabilities. Modern wireless networks may include various types of devices ranging from smartphones and tablets to low-power internet of things (IoT) sensors, each having different power consumption requirements. By embedding the DPS support information directly into the TWT setup frames, the wireless network can dynamically accommodate diverse device types without requiring separate management operations. This promotes scalability and flexibility in the wireless network, which are particularly important features in dense and highly dynamic network environments such as smart homes, industrial IoT deployments, and enterprise networks.

The DPS support negotiation mechanism may enhance service predictability and reliability. Since the DPS negotiation outcome is explicitly determined during the TWT setup phase, the STA can accurately predict its power consumption behavior throughout the session. Similarly, the AP may better manage network resources, scheduling, and buffer management based on the agreed-upon DPS support settings. This predictability is particularly valuable for applications requiring strict timing guarantees or consistent performance such as real-time video streaming, voice over IP (VoIP), and industrial automation applications.

The integration of DPS support negotiation into the TWT setup procedure (and specifically within the existing TWT setup request and TWT setup response frames) may ensure backward compatibility with existing TWT protocols and minimize the impact on protocol complexity. By utilizing reserved fields or extending existing control fields, the DPS support negotiation mechanism avoids the need for introducing new frame types or making extensive modifications to the existing TWT framework. This design approach may facilitate easier adoption into existing wireless networks and enable gradual rollout through firmware or software updates rather than requiring costly hardware changes.

By clearly defining the negotiation behaviors for different TWT negotiation outcomes (e.g., accept TWT, alternate TWT, dictate TWT, reject TWT, etc.), the DPS support negotiation mechanism provides a systematic and robust negotiation framework. This structured negotiation approach may allow for greater interoperability between vendors and devices, thereby reducing the risk of inconsistent implementations or ambiguous interpretations during negotiations.

The DPS support negotiation mechanism may improve the overall energy efficiency of wireless network. By enabling devices to use DPS during SPs when feasible, the overall power consumption across the wireless network can be significantly reduced. This not only benefits the battery life of individual devices but also contributes to the broader sustainability goals by lowering the overall energy footprint of wireless network infrastructures.

Thus, the DPS support negotiation mechanism described herein may offer several practical technological advantages in terms of flexibility, scalability, reliability, interoperability, backward compatibility, and/or energy efficiency. The DPS support negotiation mechanism may be implemented in next-generation wireless networks to provide a seamless and low-impact pathway to leverage the benefits of both DPS and TWT-based schemes.

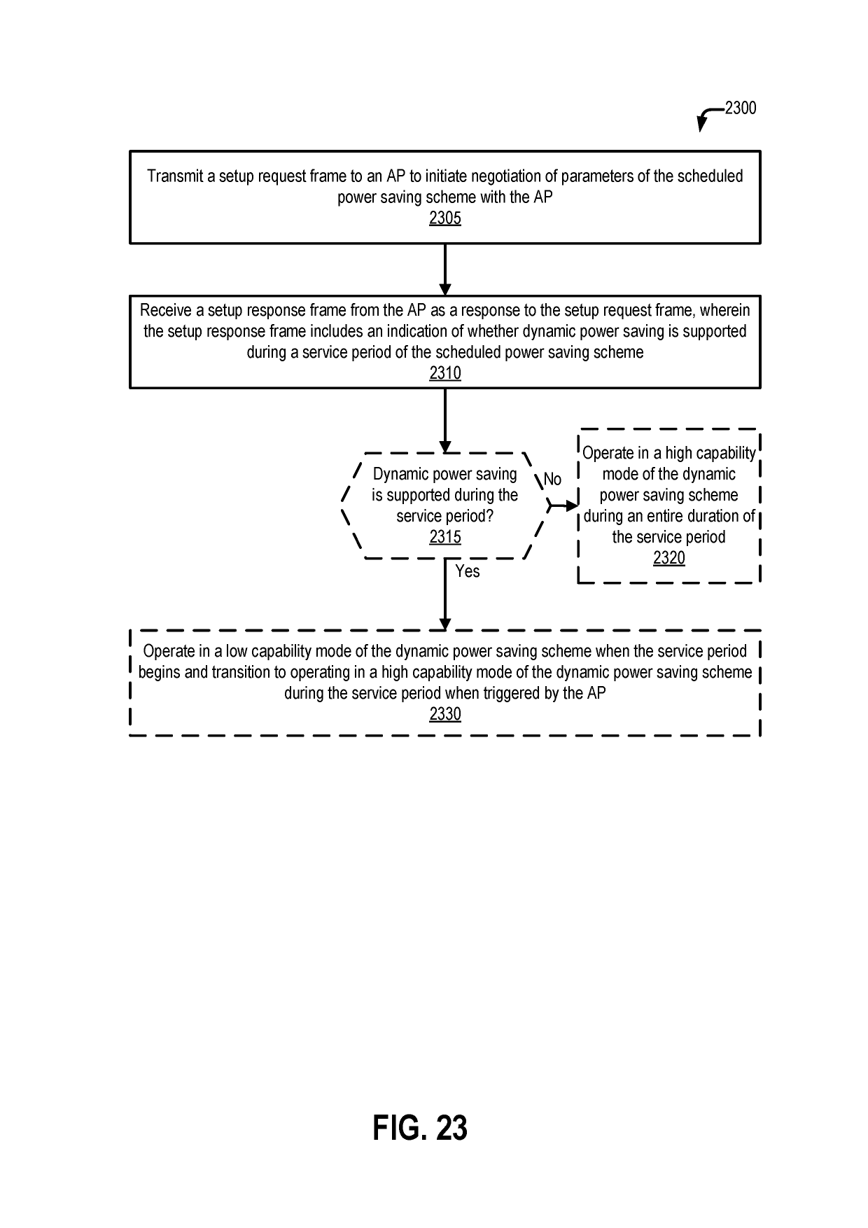

Turning now to FIG. 23, a method 2300 will be described for negotiating dynamic power saving support for a scheduled power saving scheme, in accordance with an example embodiment. The method 2300 may be performed by a STA. The STA may be implemented by a wireless device (e.g., wireless device 104).

At operation 2305, the STA transmits a setup request frame to an AP to initiate negotiation of parameters of the scheduled power saving scheme with the AP.

At operation 2310, the STA receives a setup response frame from the AP as a response to the setup request frame, wherein the setup response frame includes an indication of whether dynamic power saving is supported during a service period of the scheduled power saving scheme.

In an embodiment, at operation 2315, the STA determines whether dynamic power saving is supported during the service period (based on the indication included in the setup response frame). If dynamic power saving is not supported, the flow may proceed to operation 2320 at which the STA operates in a high capability mode of the dynamic power saving scheme during an entire duration of the service period. Otherwise, if dynamic power saving is supported, the flow may proceed to operation 2330 at which the STA operates in a low capability mode of the dynamic power saving scheme when the service period begins and transitions to operating in a high capability mode of the dynamic power saving scheme during the service period when triggered by the AP.

In an embodiment, the scheduled power saving scheme is r-TWT. In such an embodiment, the indication may be carried in a UHR power save capability field (e.g., field 1705 shown in FIG. 17) included in a TWT element included in the setup response frame. In an embodiment, the indication is encoded using a single bit.

In an embodiment, the setup request frame includes suggested timing parameters (e.g., using a suggest TWT setup command) or demanded timing parameters (e.g., using a demand TWT setup command) of the scheduled power saving scheme and an indication that support for dynamic power saving is desired. In such an embodiment, the setup response frame may include alternate timing parameters (e.g., using an alternate TWT setup command) or dictated timing parameters (e.g., using a dictate TWT setup command) of the scheduled power saving scheme that are different from the suggested timing parameters or the demanded timing parameters with respect to at least one timing parameter. In such case, the indication (included in the setup response frame) may match the desire of the STA (e.g., indicate that dynamic power saving is supported) or not match the desire of the STA (e.g., indicate that dynamic power saving is not supported).

In an embodiment, the setup response frame includes finalized timing parameters (e.g., using an accept TWT setup command) of the scheduled power saving scheme. The finalized timing parameters may include a wake interval mantissa parameter and a wake interval exponent parameter that together define a periodic wake-up schedule. In an embodiment, the indication (included in the setup response frame) indicates that dynamic power saving is supported during the service period.

In an embodiment, the dynamic power saving scheme is DPS.

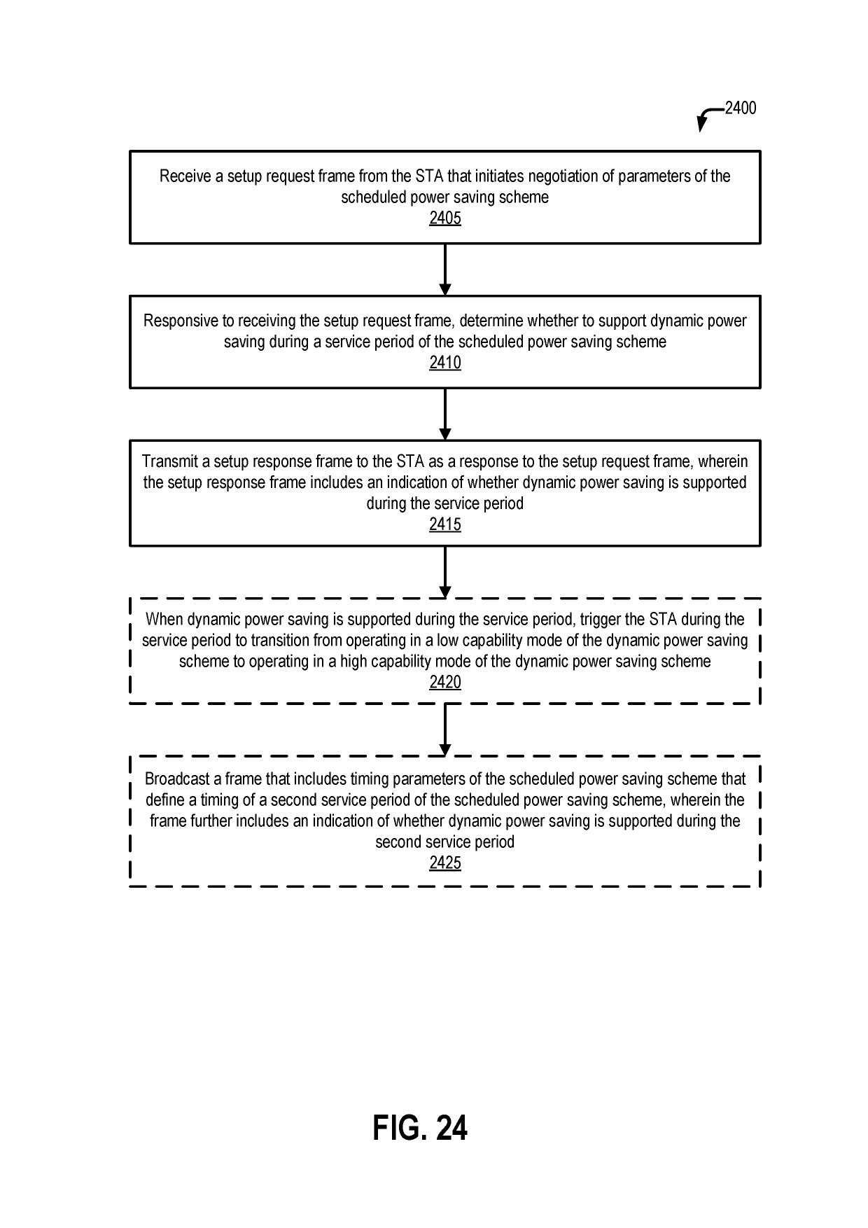

Turning now to FIG. 24, another method 2400 will be described for negotiating dynamic power saving support for a scheduled power saving scheme, in accordance with an example embodiment. The method 2400 may be performed by an AP. The AP may be implemented by a wireless device (e.g., wireless device 104).

At operation 2405, the AP receives a setup request frame from the STA that initiates negotiation of parameters of the scheduled power saving scheme.

At operation 2410, responsive to receiving the setup request frame, the AP determines whether to support dynamic power saving during a service period of the scheduled power saving scheme. In an embodiment, the determining whether to support dynamic power saving during the service period is based on one or more of: whether the setup request frame includes an indication that support for dynamic power saving is desired, network conditions, and network policies.

At operation 2415, the AP transmits a setup response frame to the STA as a response to the setup request frame, wherein the setup response frame includes an indication of whether dynamic power saving is supported during the service period.

In an embodiment, at operation 2420, when dynamic power saving is supported during the service period, the AP triggers the STA during the service period to transition from operating in a low capability mode of a dynamic power saving scheme to operating in a high capability mode of the dynamic power saving scheme.

In an embodiment, at operation 2425, the AP broadcasts a frame that includes timing parameters of the scheduled power saving scheme that define a timing of a second service period of the scheduled power saving scheme, wherein the frame further includes an indication of whether dynamic power saving is supported during the second service period. In an embodiment, the indication of whether dynamic power saving is supported during the second service period is carried in a restricted TWT information field (e.g., field 1830 shown in FIG. 18) included in a broadcast TWT parameter set field.

In an embodiment, the scheduled power saving scheme is r-TWT. In such an embodiment, the indication may be carried in a UHR power save capability field (e.g., field 1705 shown in FIG. 17) included in a TWT element included in the setup response frame. In an embodiment, the indication is encoded using a single bit.

In an embodiment, the setup request frame includes suggested timing parameters (e.g., using a suggest TWT setup command) or demanded timing parameters (e.g., using a demand TWT setup command) of the scheduled power saving scheme and an indication that support for dynamic power saving is desired. In such an embodiment, the setup response frame may include alternate timing parameters (e.g., using an alternate TWT setup command) or dictated timing parameters (e.g., using a dictate TWT setup command) of the scheduled power saving scheme that are different from the suggested timing parameters or the demanded timing parameters with respect to at least one timing parameter. In such case, the indication (included in the setup response frame) may match the desire of the STA (e.g., indicate that dynamic power saving is supported) or not match the desire of the STA (e.g., indicate that dynamic power saving is not supported).

In an embodiment, the setup response frame includes finalized timing parameters (e.g., using an accept TWT setup command) of the scheduled power saving scheme. In an embodiment, the finalized timing parameters include a wake interval mantissa parameter and a wake interval exponent parameter that together define a periodic wake-up schedule. In an embodiment, the indication (included in the setup response frame) indicates that dynamic power saving is supported during the service period.

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method performed by a station (STA) to negotiate dynamic power saving support for a scheduled power saving scheme with an access point (AP), the method comprising:
transmitting a setup request frame to the AP to initiate negotiation of parameters of the scheduled power saving scheme with the AP; and
receiving a setup response frame from the AP as a response to the setup request frame, wherein the setup response frame includes an indication of whether dynamic power saving is supported during a service period of the scheduled power saving scheme.

2. The method of claim 1, further comprising:
responsive to determining, based on the indication, that dynamic power saving is supported during the service period, operating in a low capability mode of a dynamic power saving scheme when the service period begins and transitioning to operating in a high capability mode of the dynamic power saving scheme during the service period when triggered by the AP.

3. The method of claim 1, further comprising:
responsive to determining, based on the indication, that dynamic power saving is not supported during the service period, operating in a high capability mode of a dynamic power saving scheme during an entire duration of the service period.

4. The method of claim 1, wherein the scheduled power saving scheme is restricted target wake time (r-TWT).

5. The method of claim 4, wherein the indication is carried in an ultra high reliability (UHR) power save capability field included in a target wake time (TWT) element included in the setup response frame.

6. The method of claim 5, wherein the indication is encoded using a single bit.

7. The method of claim 1, wherein the setup request frame includes suggested timing parameters or demanded timing parameters of the scheduled power saving scheme and an indication that support for dynamic power saving is desired.

8. The method of claim 7, wherein the setup response frame includes alternate timing parameters or dictated timing parameters of the scheduled power saving scheme that are different from the suggested timing parameters or the demanded timing parameters with respect to at least one timing parameter.

9. The method of claim 1, wherein the setup response frame includes finalized timing parameters of the scheduled power saving scheme.

10. The method of claim 9, wherein the finalized timing parameters include a wake interval mantissa parameter and a wake interval exponent parameter that together define a periodic wake-up schedule.

11. The method of claim 10, wherein the indication indicates that dynamic power saving is supported during the service period.

12. A method performed by an access point (AP) to negotiate dynamic power saving support for a scheduled power saving scheme with a station (STA), the method comprising:
receiving a setup request frame from the STA that initiates negotiation of parameters of the scheduled power saving scheme;
responsive to receiving the setup request frame, determining whether to support dynamic power saving during a service period of the scheduled power saving scheme; and
transmitting a setup response frame to the STA as a response to the setup request frame, wherein the setup response frame includes an indication of whether dynamic power saving is supported during the service period.

13. The method of claim 12, further comprising:
when dynamic power saving is supported during the service period, triggering the STA during the service period to cause the STA to transition from operating in a low capability mode of a dynamic power saving scheme to operating in a high capability mode of the dynamic power saving scheme.

14. The method of claim 12, wherein the scheduled power saving scheme is restricted target wake time (r-TWT).

15. The method of claim 14, wherein the indication is carried in an ultra high reliability (UHR) power save capability field included in a target wake time (TWT) element included in the setup response frame.

16. The method of claim 15, wherein the indication is encoded using a single bit.

17. The method of claim 14, further comprising:
broadcasting a frame that includes timing parameters of the scheduled power saving scheme that define a timing of a second service period of the scheduled power saving scheme, wherein the frame further includes an indication of whether dynamic power saving is supported during the second service period.

18. The method of claim 17, wherein the indication of whether dynamic power saving is supported during the second service period is carried in a restricted TWT information field included in a broadcast target wake time (TWT) parameter set field.

19. The method of claim 12, wherein the setup request frame includes suggested timing parameters or demanded timing parameters of the scheduled power saving scheme and an indication that support for dynamic power saving is desired.

20. The method of claim 19, wherein the setup response frame includes alternate timing parameters or dictated timing parameters of the scheduled power saving scheme that are different from the suggested timing parameters or the demanded timing parameters with respect to at least one timing parameter.

21. The method of claim 12, wherein the setup response frame includes finalized timing parameters of the scheduled power saving scheme.

22. The method of claim 21, wherein the finalized timing parameters include a wake interval mantissa parameter and a wake interval exponent parameter that together define a periodic wake-up schedule.

23. The method of claim 22, wherein the indication indicates that dynamic power saving is supported during the service period.

24. The method of claim 12, wherein the determining whether to support dynamic power saving during the service period is based on one or more of: whether the setup request frame includes an indication that support for dynamic power saving is desired, network conditions, and network policies.

25. A wireless device configured to implement a station (STA), the wireless device comprising:
a radio frequency transceiver;
a memory device storing a set of instructions; and
a processor coupled to the memory device, wherein the set of instructions, when executed by the processor, causes the STA to perform the method of any one of claims claim 1-11.

26. A wireless device configured to implement an access point (AP), the wireless device comprising:
a radio frequency transceiver;
a memory device storing a set of instructions; and
a processor coupled to the memory device, wherein the set of instructions, when executed by the processor, causes the AP to perform the method of any one of claims claim 12-24.
